(19) United States
(12) Patent Application Publication
(10) Pub. No.: US 2022/0413776 A1
(43) Pub. Date: Dec. 29, 2022

(54) IMAGE FORMING APPARATUS THAT STORES LINK FILE INDICATING PATH TO SECOND RESOURCE FILE IN SUB FOLDER, INSTEAD OF FIRST RESOURCE FILE, WHEN SECOND RESOURCE FILE OF SAME CONTENT AS FIRST RESOURCE FILE, INCLUDED IN IMAGE FORMING JOB SUBMITTED TO HOT FOLDER, IS STORED IN HOT FOLDER STORAGE REGION, IMAGE FORMING METHOD, AND IMAGE FORMING PROGRAM

(71) Applicant: KYOCERA Document Solutions Inc., Osaka (JP)

(72) Inventor: Naoki SEKIOKA, Osaka (JP)

(73) Assignee: KYOCERA Document Solutions Inc., Osaka (JP)

(21) Appl. No.: 17/842,163

(22) Filed: Jun. 16, 2022

(30) Foreign Application Priority Data
Jun. 24, 2021 (JP) 2021-105047

(51) Int. Cl. G06F 3/12

(52) U.S. Cl. CPC G06F 3/127; G06F 3/1257; G06F 3/122

(57) ABSTRACT

An image forming apparatus includes a hot folder storage region, an image forming device, and a hot folder controller that decides whether a second resource file, having the same content as a first resource file, is stored in the hot folder storage region, when a first image forming job is submitted to the hot folder, stores the first resource file in the sub folder, and causes the image forming device to form the image on a medium, using the first control file and the first resource file, when the second resource file is not stored, and stores, when the second resource file is stored, a link file indicating a path to the second resource file in the sub folder, acquires the second resource file using the path, and causes the image forming device to form the image on the medium, using the first control file and the second resource file.

### INCORPORATION BY REFERENCE

This application claims priority to Japanese Patent Application No. 2021-105047 filed on Jun. 24, 2021, the entire contents of which are incorporated by reference herein.

### BACKGROUND

The present disclosure relates to an image forming apparatus, an image forming method, and an image forming program, and in particular to a technique to utilize a part of an internal storage device of the image forming apparatus as a hot folder.

Image forming apparatuses (e.g., a printer, a multifunction printer, and a multifunction peripheral) are configured to execute a printing operation according to a print job described in the page description language (PDL). For the printing operation, a drawing process is executed on the basis of vector data included in the print job (including, for example, outline font data), or image data (e.g., jpeg data). In the image forming apparatuses configured as above, what is known as a hot folder is widely utilized. The hot folder refers to a utility in which a print option and imposition setting that are frequently utilized are specified in advance, in association with the hot folder, so that the user can automatically execute the print job by dragging and dropping the print job into the hot folder.

### SUMMARY

The disclosure proposes further improvement of the foregoing techniques.

In an aspect, the disclosure provides an image forming apparatus including a storage device, an image forming device, and a control device. The storage device includes a hot folder storage region for storing a hot folder, having a sub folder and in which processing detail for executing an image forming job is specified in advance. The image forming device forms an image on a recording medium. The control device includes a processor, and acts as a hot folder controller that controls an operation of the image forming device, and writing and reading of data in and from the hot folder storage region, when the processor executes a control program. When a first image forming job is submitted to the hot folder, the hot folder controller stores a first control file that enables the image forming device to form the image in the hot folder, the first control file being included in the first image forming job, and decides whether a second resource file, having a same content as a first resource file representing the image and included in the first image forming job, is stored in the hot folder storage region. When the second resource file is not stored in the hot folder storage region, the hot folder controller stores the first resource file in the sub folder, and causes the image forming device to form the image on the recording medium according to the processing detail, using the first control file and the first resource file stored in the sub folder. When the second resource file is stored in the hot folder storage region, the hot folder controller generates a link file indicating a path to the second resource file, stores the link file in the sub folder instead of the first resource file, acquires the second resource file using the path indicated by the link file, and causes the image forming device to form the image on the recording medium according to the processing detail, using the first control file and the second resource file acquired.

In another aspect, the disclosure provides an image forming method including a step of generating a hot folder having a sub folder, in a hot folder storage region of a storage device, and specifying a processing detail for executing an image forming job, in the hot folder, a step of storing in the hot folder, when a first image forming job is submitted to the hot folder, a first control file that enables an image forming device, configured to form an image on a recording medium, to form the image, the first control file being included in the first image forming job, and deciding whether a second resource file, having a same content as a first resource file representing the image and included in the first image forming job, is stored in the hot folder storage region, a step of storing the first resource file in the sub folder, and causing the image forming device to form the image on the recording medium according to the processing detail, using the first control file and the first resource file stored in the sub folder, when the second resource file is not stored in the hot folder storage region, a step of generating, when the second resource file is stored in the hot folder storage region, a link file indicating a path to the second resource file, storing the link file in the sub folder instead of the first resource file, acquiring the second resource file using the path indicated by the link file, and causing the image forming device to form the image on the recording medium according to the processing detail, using the first control file and the second resource file acquired.

In still another aspect, the disclosure provides a computer readable, non-transitory recording medium containing an image forming program. The image forming program is configured to cause a processor installed in an image forming apparatus, including a storage device including a hot folder storage region for storing a hot folder, having a sub folder and in which processing detail for executing an image forming job is specified in advance, and an image forming device that forms an image on a recording medium, to store, when a first image forming job is submitted to the hot folder, a first control file that enables an image forming device to form the image, in the hot folder, the first control file being included in the first image forming job, and decide whether a second resource file, having a same content as a first resource file representing the image and included in the first image forming job, is stored in the hot folder storage region, store the first resource file in the sub folder, and cause the image forming device to form the image on the recording medium according to the processing detail, using the first control file and the first resource file stored in the sub folder, when the second resource file is not stored in the hot folder storage region, generate, when the second resource file is stored in the hot folder storage region, a link file indicating a path to the second resource file, store the link file in the sub folder instead of the first resource file, acquire the second resource file using the path indicated by the link file, and cause the image forming device to form the image on the recording medium according to the processing detail, using the first control file and the second resource file acquired.

### BRIEF DESCRIPTION OF THE DRAWINGS

FIG. 1 is a block diagram showing a functional configuration of an image forming system according to a first embodiment of the disclosure;

FIG. 2 is a flowchart showing a hot folder setting process according to the first embodiment;

FIG. 3 is a flowchart showing a hot folder utilization process according to the first embodiment;

FIG. 4 and FIG. 5 are schematic drawings for explaining the detail of the hot folder utilization process according to the first embodiment;

FIG. 6 is a schematic drawing for explaining the detail of the hot folder utilization process according to a comparative example and the first embodiment;

FIG. 7 is a flowchart showing a hot folder utilization process according to a second embodiment;

FIG. 8 is a flowchart for explaining a link file storage process according to the second embodiment;

FIG. 9 is a schematic drawing for explaining the detail of the link file storage process according to the first embodiment; and

FIG. 10 is a schematic drawing for explaining the detail of the link file storage process according to the second embodiment.

### DETAILED DESCRIPTION

Hereafter, embodiments of the disclosure will be described with reference to the drawings, in the following order.

A. First Embodiment

B. Second Embodiment

C. Variations

### A. First Embodiment

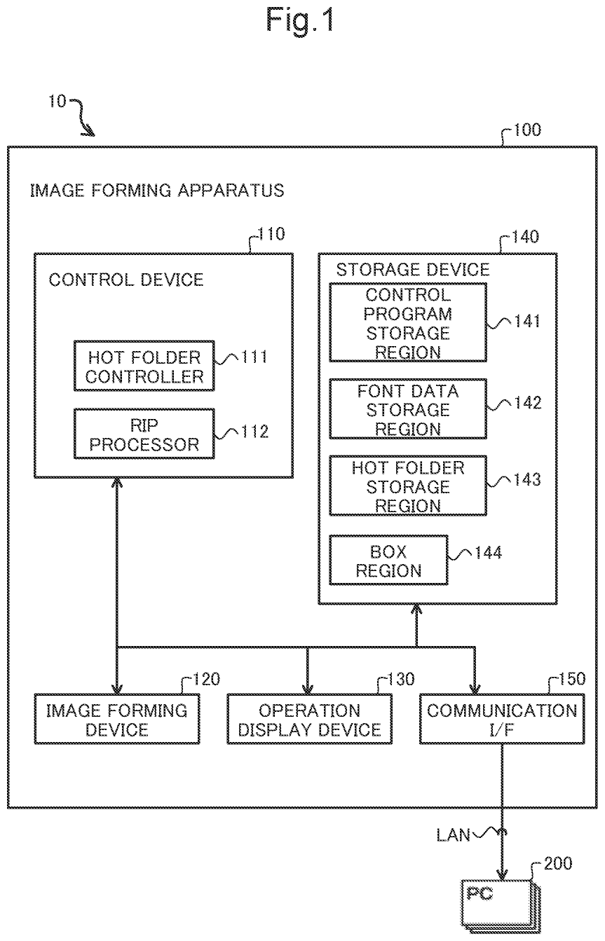

FIG. 1 is a block diagram showing a functional configuration of an image forming system 10 according to a first embodiment of the disclosure. The image forming system 10 includes an image forming apparatus 100 and a plurality of personal computers (also simply referred to as PC) 200. The image forming apparatus 100 includes a control device 110, an image forming device 120, an operation display device 130, a storage device 140, and a communication interface (I/F) 150.

The communication I/F 150 performs communication, for example using transmission control protocol/internet protocols (TCP/IP). The communication I/F 150 is connected to the plurality of personal computers 200, via a local area network (LAN), which may be simply referred to as “network”, where appropriate.

The image forming apparatus 100 is configured to receive a print job (e.g., a file of the job definition format (JDF standard or XJDF standard), also referred to as “JDF file”) containing a document content, via the communication I/F 150. The JDF standard enables a workflow including creation of the content, printing, post-press, and distribution of the printed material, to be managed as a whole. The JDF standard is based on the web-compatible job ticket standard which is open and highly expandable. The JDF file is configured as a job ticket including an XML file and a resource file.

The content is configured as the resource file, for example in the form of PDL data described in the page description language (PDL). Examples of the page description languages include KPDL, PCLXL, PostScript, PCL, RPCS, portable document format (PDF), and XPS.

The control device 110 includes a processor, and acts as a hot folder controller 111 and an RIP processor 112, when the processor executes a control program. The RIP processor 112 analyzes the PDL data to extract the objects included in the PDL data, such as a text (characters), an image, or vector graphics, and approximates a curve expressed by an outline font, Bezier of vector graphics, or a spline by minute straight lines, thereby converting the curve into polygonal vector data. The RIP processor 112 further performs a drawing operation including generating a raster line on the basis of the vector data, and halftone processing including reducing the number of gradations to the level that the image forming device 120 can reproduce.

The control device 110 includes main storage devices such as a RAM and a ROM, and a control unit such as a micro processing unit (MPU) or a central processing unit (CPU). The control device 110 has control functions with respect to various types of I/O, a universal serial bus (USB), a bus, and the interface with other hardware, and controls the entirety of the image forming apparatus 100.

The image forming device 120 forms an image on a recording medium, by electrophotography. Here, the image forming device 120 may be configured to execute ink jet printing or offset printing. The operation display device 130 acts as a touch pane. The operation display device 130 displays various menus as input screens, for the user to input an instruction.

The storage device 140 is constituted of a hard disk drive, a flash memory, or the like, which are non-transitory recording media. The storage device 140 includes a control program storage region 141, a font data storage region 142, a hot folder storage region 143, and a BOX region 144. The control program storage region 141 contains control programs (image forming program inclusive), to be executed by the control device 110, and the related data. The font data storage region 142 contains the outline font and other types of fonts. The BOX region 144 is a region secured in advance to store image data and other types of data.

In the hot folder storage region 143, the user authorized in advance can freely generate a hot folder, and specify in advance processing detail such as print setting, post-press, and distribution setting. When a JDF file to be printed is submitted to the hot folder, the hot folder controller 111 of the image forming apparatus 100 executes the printing operation, according to the processing detail specified in advance as above. The hot folder stores the XML file at one of inner positions (e.g., right under).

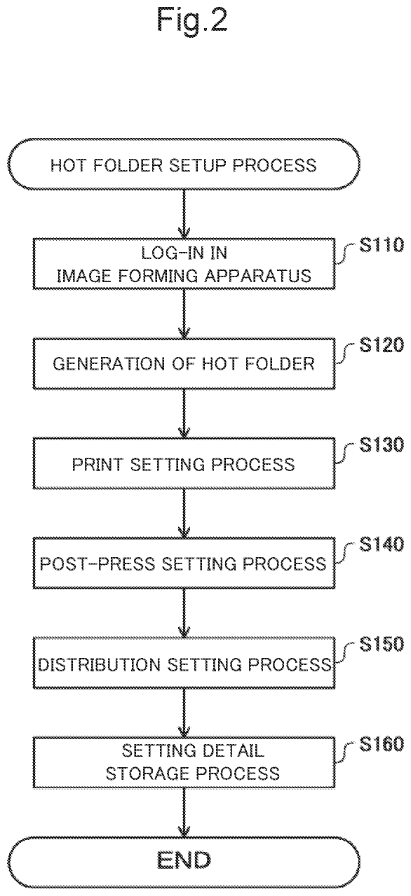

FIG. 2 is a flowchart showing a hot folder setting process according to the first embodiment. In this example, the hot folder setting process is primarily executed by the user, via the personal computer 200 acting as a terminal device. Here, it will be assumed that the user is registered in the storage device 140 of the image forming apparatus 100, as a person authorized in advance to set up the hot folder.

At step S110, the user requests the image forming apparatus 100 to permit logging in, from the personal computer 200. The control device 110 of the image forming apparatus 100 permits the log-in from the personal computer 200, according to the user information registered in the storage device 140.

At step S120, the hot folder controller 111 generates the hot folder, in response to the instruction from the user received via the personal computer 200. In the hot folder generation process, the hot folder controller 111 generates the hot folder in the hot folder storage region 143 in the storage device 140 of the image forming apparatus 100. More specifically, the hot folder controller 111 controls the writing and reading of data in and from the hot folder storage region 143, to generate a new hot folder with a desired name.

When a plurality of hot folders are included in the hot folder storage region 143 because of the generation of the new hot folder, the hot folder controller 111 also generates a shared folder. The shared folder is for storing a resource file to be utilized in common, by a plurality of JDF files respectively submitted to the plurality of hot folders. The shared folder contributes to efficiently managing the storage region, by encouraging the shared use of the resource file having the same content.

At step S130, the user executes the print setting process. In the print setting process, the user can specify predetermined printing conditions, such as the type and size of the printing medium, whether color or B/W printing, and the layout.

At step S140, the user executes the post-press setting process. In the post-press setting process, the user can specify, as the post-press operation, the detail of cutting in size, folding, or trimming, or the detail of book binding, such as collation of signature, binding, cover gluing-on, or three-sided cutting.

At step S150, the user executes the distribution setting process. In the distribution setting process, the user can determine the distribution destination and the packing form of the printed material. At step S160, the hot folder controller 111 of the image forming apparatus 100 stores the detail specified at step S130 to step S150 in the hot folder storage region 143, in association with the hot folder that has been newly generated.

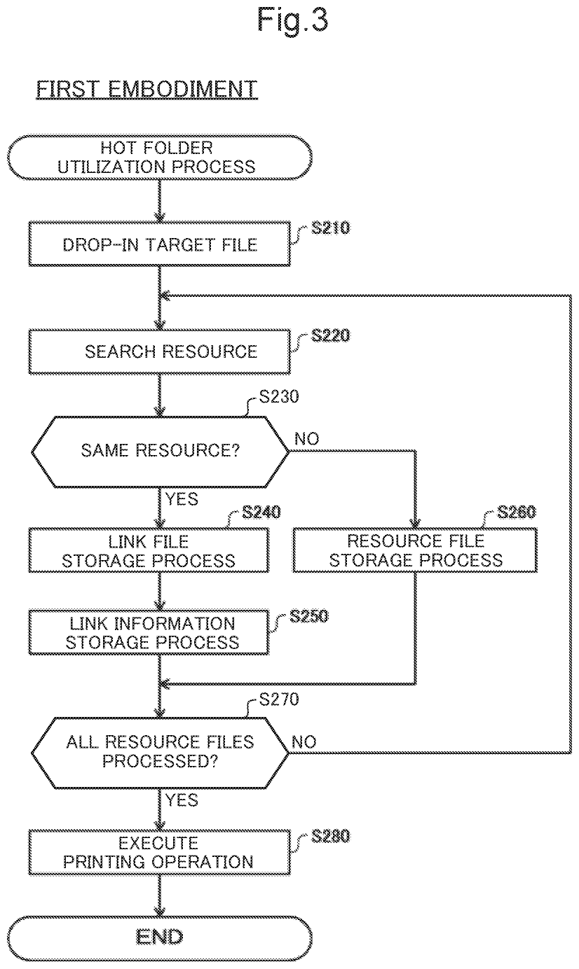

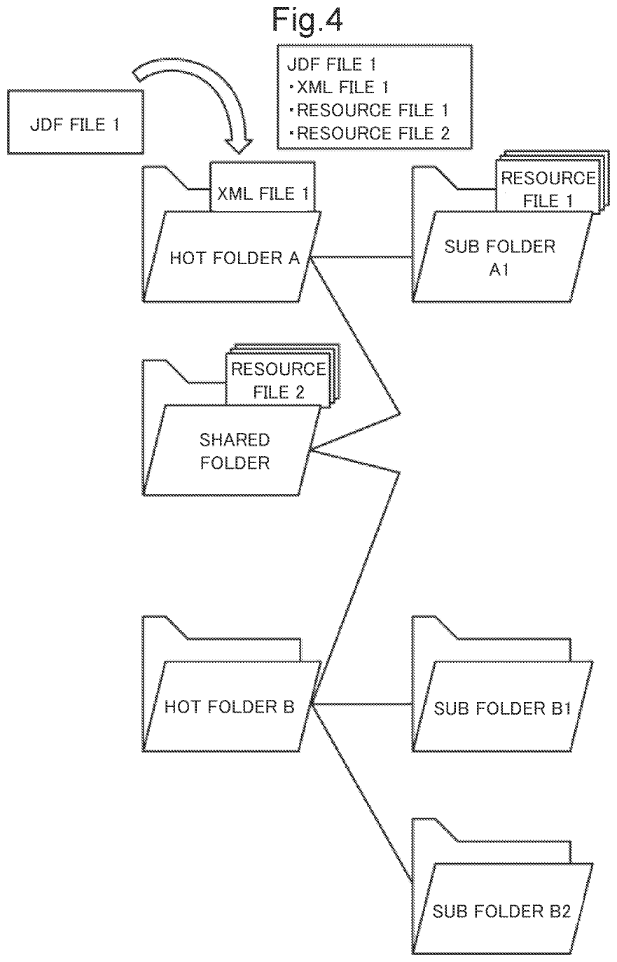

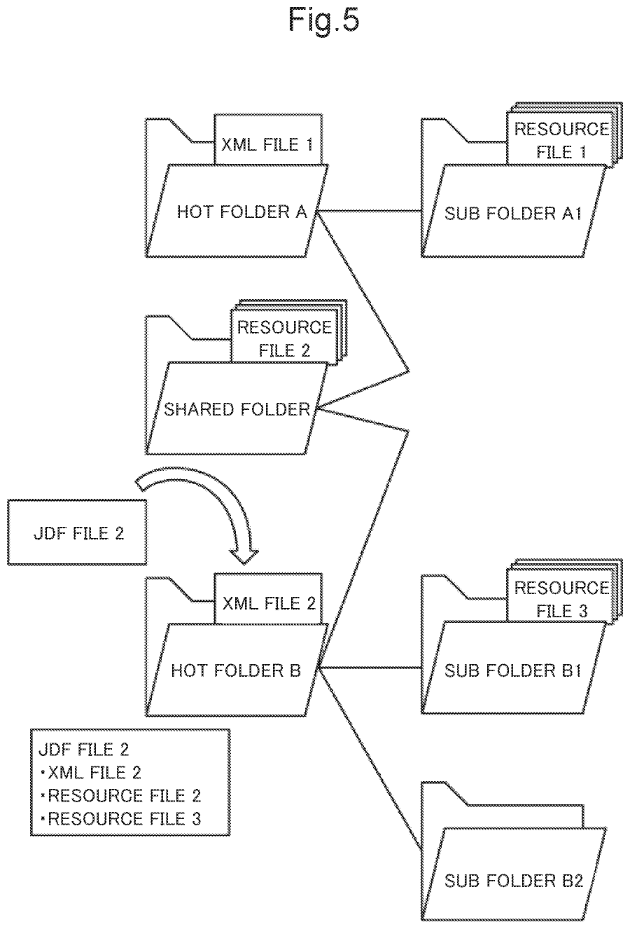

FIG. 3 is a flowchart showing a hot folder utilization process according to the first embodiment. FIG. 4 and FIG. 5 are schematic drawings for explaining the detail of the hot folder utilization process according to the first embodiment. In this example, a hot folder A, a hot folder B, and a shared folder are included in the hot folder storage region 143. In the hot folder A and the hot folder B, the processing details such as the print settings that are different from each other, are specified in advance. In the hot folder A, a sub folder A1 is included. In the hot folder B, a sub folder B1 and a sub folder B2 are included.

At step S210, the user drops in the JDF file to be printed, in the hot folder. To be more detailed, the user drops in the JDF file in the hot folder in the hot folder storage region 143, via the operation display device of the personal computer 200. In this example, the user drops in a JDF file 1 in the hot folder A in the hot folder storage region 143, as a first JDF file, as shown in FIG. 4.

The JDF file 1 includes an XML file 1 the icon of which is visible, a resource file 1 the icon of which is invisible, and a resource file 2 the icon of which is invisible. The resource files 1 and 2 each represent the content of the printed material, and are designated by the link in the XML file 1. It will be assumed, however, that the XML file 1 specifies that the resource file 2 is a resource file to be shared, to be utilized in common by other JDF files. The printed material includes various contents, such as a cover, a script, and an illustration. These contents can be expressed by a resource file described in the page description language (e.g., pdf file).

At step S220, the hot folder controller 111 of the control device 110 executes a resource search process. In the resource search process, the hot folder controller 111 searches the hot folder storage region 143 with respect to the resource files stored therein, for a resource file having the same content as the resource file 1 or 2. The hot folder controller 111 decides the identity of the resource files, depending on whether both of the file name and the file size accord with each other.

Upon finding out the resource file 1 or 2 in the hot folder storage region 143 (Yes at step S230), the hot folder controller 111 proceeds to step S240. In the case where neither of the resource files 1 and 2 have been found in the hot folder storage region 143 (NO at step S230), the hot folder controller 111 proceeds to step S260. Since neither of the resource files 1 and 2 are stored in the hot folder storage region 143 in this example, the hot folder controller 111 proceeds to step S260.

At step S260, the hot folder controller 111 executes a resource file storage process. In the resource file storage process, the hot folder controller 111 stores the resource file 1 in the sub folder A1, and stores the resource file to be shared 2, designated to be shared, in the shared folder. The hot folder controller 111 edits the XML file 1, to post a new link to the resource file 1 in the sub folder A1 and the resource file 2 in the shared folder. The hot folder controller 111 executes the mentioned operation (step S220 to step S260), with respect to all the resource files designated by the XML file 1 (step S270).

At step S280, the hot folder controller 111 acquires the resource file 1 from the sub folder A1, and the resource file 2 from the shared folder, using path information stored in the XML file 1. The RIP processor 112 of the control device 110 analyzes the resource file 1 and the resource file 2, which are PDL data, thereby acquiring the image data, and generates the vector data. The RIP processor 112 then reads out the outline font and other fonts from the font data storage region 142, and performs the drawing operation to generate the raster line on the basis of the vector data generated, and the halftone processing to reduce the number of gradations to the level that the image forming device 120 can reproduce.

At step S280, the hot folder controller 111 also causes the image forming device 120 to execute the printing operation, on the basis of the XML file 1. The hot folder controller 111 causes the image forming device 120 to execute the printing operation, in accordance with the print setting, the post-press setting, and the distribution setting specified in advance in the hot folder A.

In this example, the user drops in the JDF file 2, after dropping in the JDF file 1. In this example, the user drops in the JDF file 2 in the hot folder B (step S210).

The JDF file 2 includes an XML file 2, the resource file to be shared 2, designated to be utilized in common by other JDF files, and a resource file 3. Here, it is assumed that the XML file 2 specifies that the resource file 2 is the resource file to be shared, designated to be utilized in common by other JDF files. In this example, the hot folder controller 111 executes the operation of step S220 to step S260, in the same way as the drop-in of the JDF file 1.

Accordingly, the hot folder controller 111 stores the resource file 3 in the sub folder B1, in response to the drop-in of the JDF file 2. The hot folder controller 111 edits the XML file 2, to post a new link to the resource file 3 in the sub folder B1 and the resource file 2 in the shared folder.

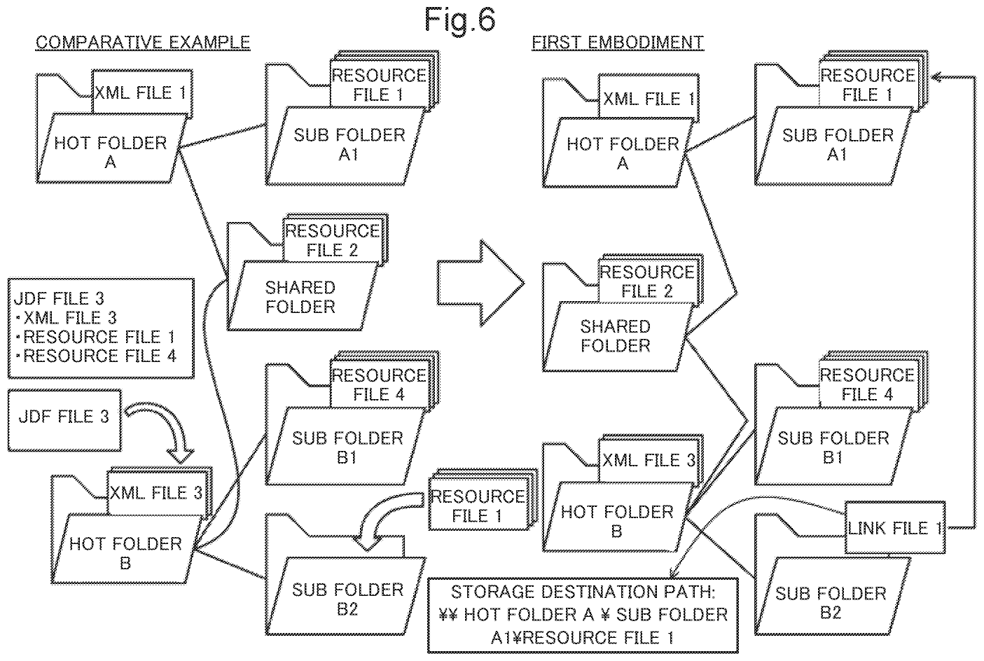

FIG. 6 is a schematic drawing for explaining the detail of the hot folder utilization process according to a comparative example and the first embodiment. In this example, the user drops in the JDF file 3, after dropping in the JDF file 2. In this example, the user drops in the JDF file 3 in the hot folder B (step S210).

The JDF file 3 includes an XML file 3, the resource file 1, and a resource file 4. The resource file 1 is already stored in the sub folder A1 in the hot folder A as a part of the JDF file 1, with the same file name.

At step S220, the hot folder controller 111 executes a resource search process. In the resource search process, the hot folder controller 111 searches the hot folder storage region 143 with respect to the resource files stored therein, for a resource file having the same content as the resource file 1 or 4. In this example, the hot folder controller 111 finds out the resource file 1 in the sub folder A1 in the hot folder storage region 143 (Yes at step S230), and proceeds to step S240.

At step S240, the hot folder controller 111 executes a link file storage process. In the link file storage process, the hot folder controller 111 generates, at first, a link file 1 storing therein the data indicating the path to the resource file 1 that is already stored. Since the link file 1 only serves to store the data indicating the path to the resource file 1 in the form of a text, the link file 1 is significantly smaller in file size, than the resource file 1.

In the first embodiment, as shown in FIG. 6, the hot folder controller 111 stores the link file 1 in the sub folder B2. In the comparative example, on the other hand, the hot folder controller 111 stores the resource file 1 in the sub folder B2. Therefore, the arrangement according to the first embodiment can reduce the occupied region in the hot folder storage region 143, compared with the comparative example.

Here, the hot folder controller 111 may also execute the resource search process, before the JDF file 3 is transmitted from the personal computer 200. In this case, the image forming system 10 may skip the transmission of the resource file 1 from the personal computer 200 to the image forming apparatus 100. Such an arrangement allows the image forming system 10 to excluding an unnecessary communication traffic in the LAN, thereby efficiently managing the network.

At step S250, the hot folder controller 111 executes a link information storage process. In the link information storage process, the hot folder controller 111 stores the link information, for example in the shared folder. The link information includes the link destination (in this example, the resource file 1 in the sub folder A1), and the link source (in this example, the XML file 1 in the hot folder A and the XML file 3 in the hot folder B), of each of the link files (in this example, link file 1).

At step S260, the hot folder controller 111 executes the resource file storage process. In the resource file storage process, the hot folder controller 111 stores the resource file 4 in the sub folder B1. The hot folder controller 111 continues with the mentioned operation (step S220 to step S260), until the operation with respect to all the resource files is finished (step S270).

At step S280, the hot folder controller 111 acquires the resource file 4 from the sub folder B1, and the link file 1 from the sub folder B2, using path information stored in the XML file 3. The hot folder controller 111 acquires the resource file 1 from the sub folder A1, using the path information stored in the link file 1. The RIP processor 112 of the control device 110 analyzes the resource file 1 and the resource file 4, which are PDL data, thereby acquiring the vector data, and performs the drawing operation to generate the raster line on the basis of the vector data, and the halftone processing to reduce the number of gradations to the level that the image forming device 120 can reproduce.

Now, in the case of utilizing a part of the internal storage device of the image forming apparatus as the hot folder, a given storage region may be shared with a function other than the hot folder (e.g., BOX function). The storage region that can be assigned to the hot folder is limited, and it is not easy to expand the assigned region during the operation of the image forming apparatus. Therefore, it is preferable to utilize the storage region more efficiently.

However, the image forming system 10 according to the first embodiment can prevent the resource files of the same content from being stored in duplication, in the storage device 140. Therefore, the image forming apparatus 100 can efficiently make use of the storage region in the storage device 140.

In this embodiment, the hot folder controller 111 is configured to automatically delete the JDF file 1 from the hot folder A, after the printing of the JDF file 1 is finished. In this case, the hot folder controller 111 deletes the other files in the JDF file 1, leaving only the resource file 1 according to the link information, because the printing of the JDF file 3, which is the link source to the resource file 1, has not yet been finished. In other words, when the presence of the image forming job of the link source to the resource file 1 (in this example, JDF file 3) is confirmed, the hot folder controller 111 excludes the resource file 1 from the files to be deleted, but deletes the resource file when the presence of such image forming job is not confirmed.

However, the hot folder controller 111 may keep the resource files in the shared folder, for example for a predetermined period of time, after deleting all the JDF files scheduled to be used. Such an arrangement enables the resource files that are frequently used in the plurality of JDF files to be maintained in the form of a library in the shared folder, thereby encouraging the efficient utilization of the resource, and enabling the efficient utilization of the storage region.

### B. Second Embodiment

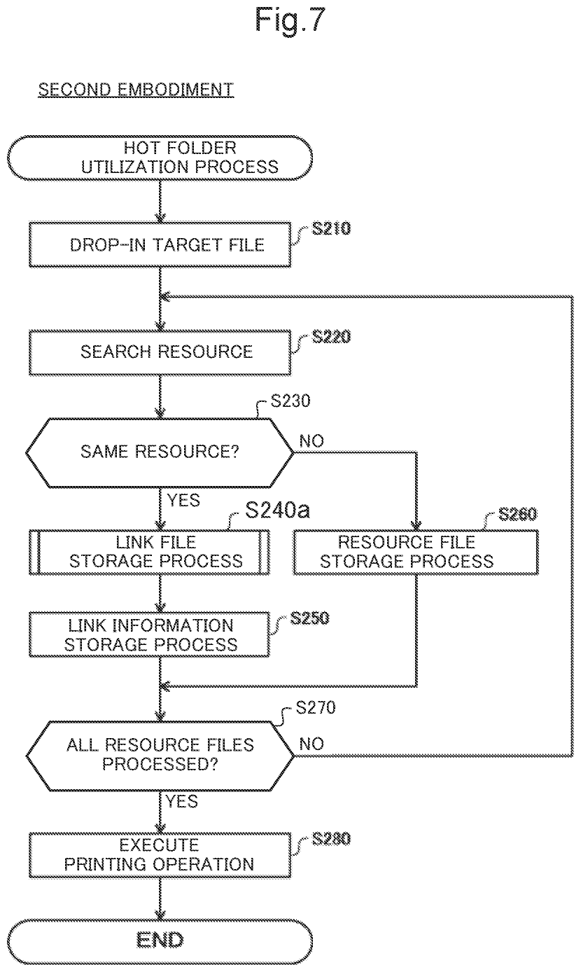

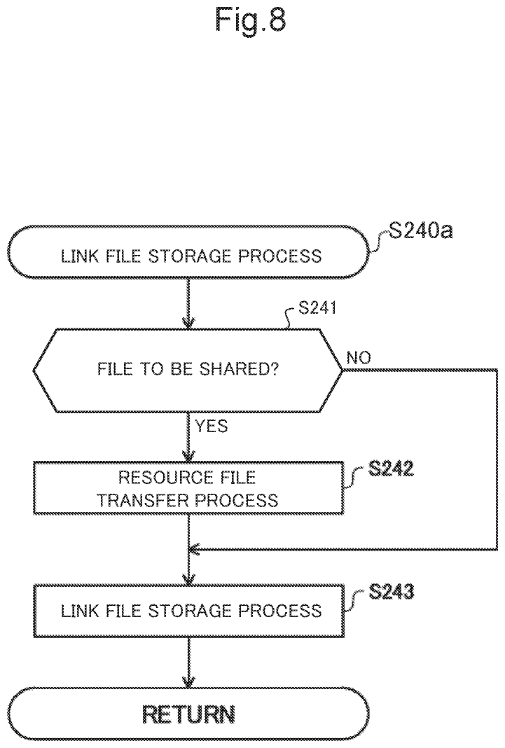

FIG. 7 is a flowchart showing a hot folder utilization process according to a second embodiment. FIG. 8 is a flowchart for explaining a link file storage process according to the second embodiment. The hot folder utilization process according to the second embodiment is different from the hot folder utilization process according to the first embodiment, in that the link file storage process (step S240) is substituted with the link file storage process (step S240a) according to the second embodiment.

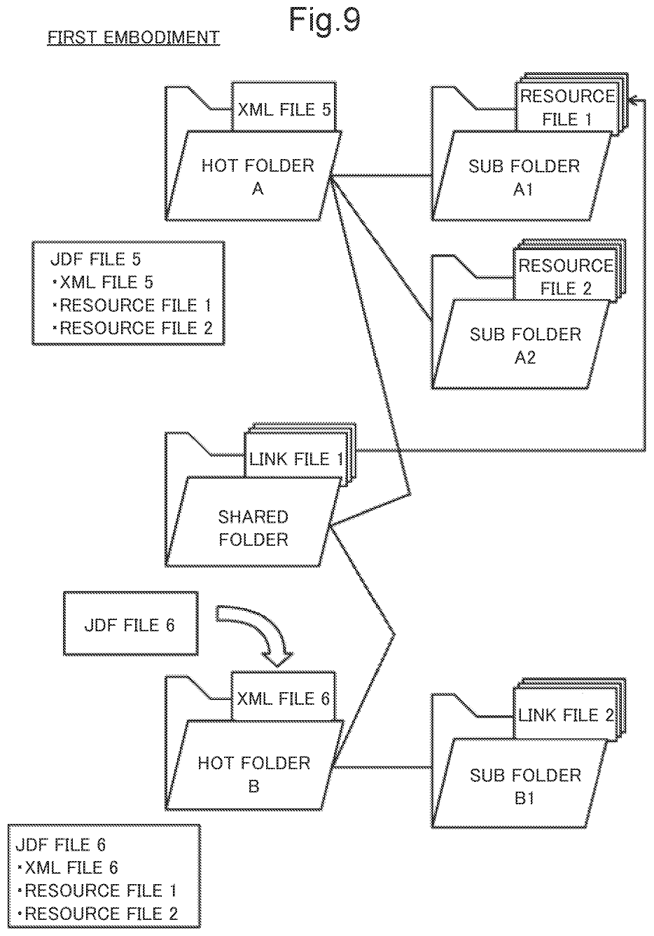

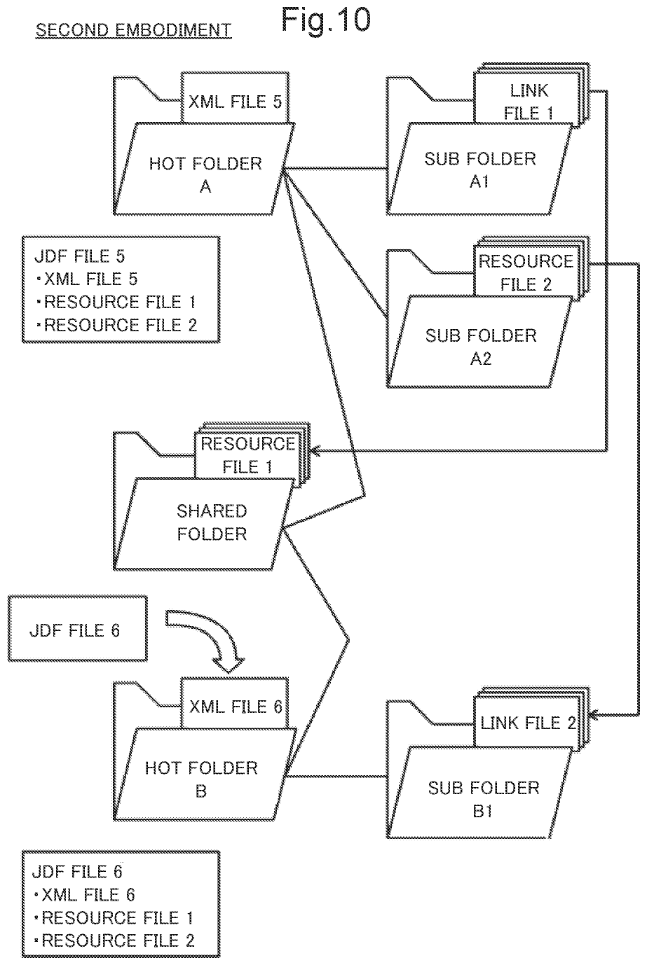

FIG. 9 is a schematic drawing for explaining the detail of the link file storage process according to the first embodiment. FIG. 10 is a schematic drawing for explaining the detail of the link file storage process according to the second embodiment. In these examples, it is assumed that the user has dropped in a JDF file 5 including an XML file 5 and the resource files 1 and 2, in the hot folder A, and then dropped in a JDF file 6 including an XML file 6 and the resource file 1 and 2, in the hot folder B.

In the case of the link file storage process according to the first embodiment, the hot folder controller 111 generates the link file 1 and stores the link file 1 in the shared folder, instead of storing the resource file 1 of the JDF file 6, and generates the link file 2 and stores the link file 2 in the sub folder B1, instead of storing the resource file 2 of the JDF file 6 (see FIG. 9). The hot folder controller 111 stores the path information to the resource file 1 in the sub folder A1, in the like file 1 in the shared folder, and stores the path information to the resource file 2 in the sub folder A2, in the like file 2 in the sub folder B1.

The link file storage process (step S240a) according to the second embodiment is started, like the link file storage process (step S240) according to the first embodiment, when the duplicated resource (resource file 1) is detected (Yes at step S230).

At step S241, the hot folder controller 111 analyzes the XML file 6, and decides whether the duplicated resource is a resource file to be shared, designated to be used in common by other JDF files. When the shared use of the duplicated resource is designated (Yes at step S241), the hot folder controller 111 proceeds to step S242, and when the shared use of the duplicated resource is not designated (No at step S241), the hot folder controller 111 proceeds to step S243 (see FIG. 8).

It will be assumed that, in this example, the XML file 6 specifies that the resource file 1 is designated for shared use, and that the resource file 2 is not designated for shared use. The hot folder controller 111 proceeds to step S242 with respect to the resource file 1, and proceeds to step S243 with respect to the resource file 2.

At step S242, the hot folder controller 111 executes a resource file transfer process, with respect to the resource file 1. In the resource file transfer process, the hot folder controller 111 rewrites the path to the resource file 1 in the sub folder A1 (directory in the hot folder storage region 143), in other words changes the storage location, and transfers the resource file 1 to the shared folder. By rewriting the directory, the retrieval and the writing of the resource file 1 can be skipped, in the changing of the storage location.

At step S243, the hot folder controller 111 executes the link file storage process, with respect to the resource file 1. In the link file storage process, the hot folder controller 111 generates and stores the link file 1 in the sub folder A1, instead of the resource file 1.

At step S243, the hot folder controller 111 executes the link file storage process, also with respect to the resource file 2. In this link file storage process, the hot folder controller 111 generates and stores the link file 2 in the sub folder B1, instead of the resource file 2.

The resource file in the shared folder can be kept in the shared folder, for example for a predetermined period of time, after all the JDF files scheduled to be used are deleted. Such an arrangement enables the resource files that are frequently used in the plurality of JDF files to be maintained in the form of a library in the shared folder, thereby encouraging the efficient utilization of the resource, and enabling the efficient utilization of the storage region.

As described above, the image forming system 10 according to the second embodiment smoothly sets the resource files that are frequently used in the plurality of JDF files in the form of a library, thereby encouraging the efficient utilization of the resource, and enabling the efficient utilization of the storage region.

### C. Variations

The disclosure may be realized in the form of the following variations, in addition to the foregoing embodiments.

Variation 1

Regarding the identity between the resource files, the hot folder controller 111 decides that the files have the same content when both of the file name and the file size accord with each other, in the foregoing embodiments. However, the disclosure is not limited to such a decision method. For example, the hot folder controller 111 may decide that the files are duplicated files of the same content, when the hash value of the file content is the same, though the file names are different from each other. Various algorithms may be employed to calculate the hash value, among which it is preferable to use the algorithms such as SHA256 or SHA-3, which impedes creation of two different files with the same hash value, from the viewpoint of preventing a trouble originating from accidental coincidence.

Variation 2

In the link information storage process according to the foregoing embodiments, the link information includes the link destination and the link source of each of the link files (e.g., link file 1). However, the information for deciding the identity of the resource files, including the combination of the file name and the file size, or the hash value of the resource files, may be integrally managed with the link information, as shared information. Such an arrangement eliminates the need to calculate the hash value, when searching for the files of the same content.

Variation 3

Although the print job is configured as the print job ticket of the JDF standard, including the XML file and the resource file, in the foregoing embodiments, the disclosure is not limited to such embodiments. The disclosure is applicable to the image forming apparatus configured to form an image, when the job ticket, including a control file for controlling the printing operation, such as the XML file, and the resource file used in the control file, is submitted to the hot folder. The job ticket is also called the image forming job.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
a storage device including a hot folder storage region for storing a hot folder, having a sub folder and in which processing detail for executing an image forming job is specified in advance;
an image forming device that forms an image on a recording medium; and
a control device including a processor, and configured to act as a hot folder controller that controls an operation of the image forming device and writing and reading of data in and from the hot folder storage region, when the processor executes a control program,
the hot folder controller being configured to:
store in the hot folder, when a first image forming job is submitted to the hot folder, a first control file that enables the image forming device to form the image, the first control file being included in the first image forming job, and decide whether a second resource file, having a same content as a first resource file representing the image and included in the first image forming job, is stored in the hot folder storage region;
store the first resource file in the sub folder, when the second resource file is not stored in the hot folder storage region, and cause the image forming device to form the image on the recording medium according to the processing detail, using the first control file and the first resource file stored in the sub folder; and
generate a link file indicating a path to the second resource file, when the second resource file is stored in the hot folder storage region, store the link file in the sub folder instead of the first resource file, acquire the second resource file using the path indicated by the link file, and cause the image forming device to form the image on the recording medium according to the processing detail, using the first control file and the second resource file acquired.

2. The image forming apparatus according to claim 1,
wherein the hot folder controller stores link information indicating a link destination of the link file and the first image forming job being a link source, in the hot folder storage region, and
when a request to delete a second image forming job including the second resource file is received, the hot folder controller excludes the second resource file from files to be deleted, when the first image forming job which is the link source of the second resource file is present, other than the second image forming job, and deletes the second resource file, when the first image forming job is not present.

3. The image forming apparatus according to claim 1,
wherein the hot folder controller decides that the second resource file is stored in the hot folder storage region, when the resource file having a same hash value as a hash value of the first resource file is stored in the hot folder storage region.

4. The image forming apparatus according to claim 3,
wherein a shared folder is further stored in the hot folder storage region,
the hot folder controller stores the first resource file in the shared folder instead of the sub folder, when the first control file designates the first resource file as a resource file to be shared with another image forming job, and when the second resource file is not stored in the hot folder storage region, and
changes a storage location of the second resource file to the shared folder, generates a link file indicating a path to the second resource file at the changed storage location, and stores the link file in the sub folder, when the first control file designates the first resource file as the resource file to be shared, and when the second resource file is stored in the sub folder in the hot folder storage region.

5. The image forming apparatus according to claim 1,
wherein the hot folder controller decides that the second resource file is stored in the hot folder storage region, when the resource file, having a same file name and a same file size as a file name and a file size of the first resource file, is stored in the hot folder storage region.

6. An image forming method comprising:
a step of generating a hot folder having a sub folder, in a hot folder storage region of a storage device, and specifying processing detail for executing an image forming job, in the hot folder;
a step of storing in the hot folder, when a first image forming job is submitted to the hot folder, a first control file that enables an image forming device, configured to form an image on a recording medium, to form the image, the first control file being included in the first image forming job, and deciding whether a second resource file, having a same content as a first resource file representing the image and included in the first image forming job, is stored in the hot folder storage region;
a step of storing the first resource file in the sub folder, and causing the image forming device to form the image on the recording medium according to the processing detail, using the first control file and the first resource file stored in the sub folder, when the second resource file is not stored in the hot folder storage region; and
a step of generating, when the second resource file is stored in the hot folder storage region, a link file indicating a path to the second resource file, storing the link file in the sub folder instead of the first resource file, acquiring the second resource file using the path indicated by the link file, and causing the image forming device to form the image on the recording medium according to the processing detail, using the first control file and the second resource file acquired.

7. A computer readable, non-transitory recording medium having an image forming program recorded thereon, the image forming program being configured to cause a processor, installed in an image forming apparatus including a storage device including a hot folder storage region for storing a hot folder, having a sub folder and in which processing detail for executing an image forming job is specified in advance, and an image forming device that forms an image on a recording medium, to:
store in the hot folder, when a first image forming job is submitted to the hot folder, a first control file that enables an image forming device to form the image, the first control file being included in the first image forming job, and decide whether a second resource file, having a same content as a first resource file representing the image and included in the first image forming job, is stored in the hot folder storage region;
store the first resource file in the sub folder, and cause the image forming device to form the image on the recording medium according to the processing detail, using the first control file and the first resource file stored in the sub folder, when the second resource file is not stored in the hot folder storage region; and
generate, when the second resource file is stored in the hot folder storage region, a link file indicating a path to the second resource file, store the link file in the sub folder instead of the first resource file, acquire the second resource file using the path indicated by the link file, and cause the image forming device to form the image on the recording medium according to the processing detail, using the first control file and the second resource file acquired.
